(19) United States
(12) Patent Application Publication
(10) Pub. No.: US 2026/0018351 A1
(43) Pub. Date: Jan. 15, 2026

(54) Magnetic Conduction Mechanism Applied to Key Switch

(71) Applicant: DONGGUAN CITY KAIHUA ELECTRONICS CO.LTD, Dongguan, Guangdong (CN)

(72) Inventors: Fuxi WU, Dongguan, Guangdong (CN); Panhao LV, Dongguan, Guangdong (CN)

(21) Appl. No.: 18/995,803

(22) PCT Filed: Dec. 4, 2023
(86) PCT No.: PCT/CN2023/136102

§ 371 Date: Jan. 16, 2025

(30) Foreign Application Priority Data
Dec. 13, 2022 (CN) 202223362502.8

(51) Int. Cl. H01H 13/14

(52) U.S. Cl. CPC H01H 13/14

(57) ABSTRACT

A magnetic conduction mechanism applied to a push-button switch, the magnetic conduction mechanism comprising a base, a balance frame assembly arranged on the base, a conducting assembly, and a driving rod which is driven by the balance frame assembly to trigger the conducting assembly to carry out connection and disconnection, wherein the conducting assembly comprises a magnet linked to the driving rod and an inductive switch which is electrically connected to a PCB and corresponds to the magnet. The magnetic conduction mechanism applied to a push-button switch has the advantages of being less prone to aging, a long service life, good contact stability and being free of electrical shaking, and the connection and disconnection accuracy is high, thus improving the sensitivity of the push-button switch, and achieving a reduction in the number of internal components and occupying less of an internal space.

### TECHNICAL FIELD

The utility model relates to the field of key switches, in particular to a magnetic conduction mechanism applied to key switches.

### TECHNICAL BACKGROUND

In the existing key switch, in order to improve the pressing balance, a balance frame structure is usually added inside the key switch, so that when the key cap on the key switch is pressed at any position, it can move down smoothly, thus improving the pressing balance.

For the conducting structure of the key switch, the physical conducting structure is usually adopted, and the key cap or guide core triggers the contact and separation between the moving piece and the static piece to realize the conducting and disconnecting functions of the key switch. This physical conduction structure not only has the problems of easy aging, short service life, poor contact stability and electrical jitter, but also easily affects the normal operation of the key switch when dust enters it. Moreover, after repeated pressing, the contact surface of the structure is easy to wear and the service life of the product is easy to decay.

At the same time, when the balance frame structure and the physical conduction structure are added at the same time in the existing key switch, the internal components are increased and the occupied space is large.

### SUMMARY OF UTILITY MODEL

In view of the above shortcomings, the utility model aims to provide a magnetic conduction mechanism applied to the key switch, which not only has the advantages of not aging easily, long service life, good contact stability, no electrical jitter, etc., but also has high accuracy of conduction and disconnection actions, improves the sensitivity of the key switch, and reduces internal components and the occupation of internal space.

The technical scheme adopted by the utility model is as follows:

The invention relates to a magnetic conduction mechanism applied to a key switch, which is characterized by comprising a base, a balance frame component arranged on the base, a conduction component, and a driving rod driven by the balance frame component and triggering the conduction component to be turned on and off, wherein the conduction component comprises a magnet linked with the driving rod, and an induction switch electrically connected to a PCB and corresponding to the magnet.

As a further improvement of the utility model, a yielding opening for the magnet to move up and down is formed on the base.

As a further improvement of the utility model, the induction switch is located below the yielding opening.

As a further improvement of the utility model, the magnet is fixedly arranged on the lower end face of one end of the driving rod.

As a further improvement of the utility model, a pressing linkage block is arranged at one end of the driving rod close to the magnet, and a pressing lug located above the pressing linkage block is convexly arranged on the balance frame assembly.

As a further improvement of the utility model, an upper opening is formed on the driving rod, and a mounting seat embedded in the upper opening is arranged on the base, and one end of the driving rod far away from the pressing linkage block is rotatably connected with the mounting seat.

As a further improvement of the utility model, the induction switch is one of a magnetic inductor and a Hall element.

As a further improvement of the utility model, the balance frame assembly comprises a balance frame A rotatably connected to the base, a balance frame B rotatably connected to the base and the balance frame A respectively, and a tension spring connected between the balance frame A and the balance frame B.

The utility model has the beneficial effects that: By adding the balance frame assembly, combining the driving rod with the magnetic conduction assembly (magnet and induction switch), and combining the pressing balance function with the pressing conduction function by the linkage action of the driving rod to replace the traditional physical conduction structure, the on-off function of the key switch is realized, which not only has the advantages of not being easy to age, long service life, good contact stability, no electrical jitter and the like, but also has high accuracy of the on-off action, improves the sensitivity of the key switch, and reduces internal components.

The above is an overview of the technical scheme of the utility model, and the following is a further explanation of the utility model with the attached drawings and specific embodiments.

### BRIEF DESCRIPTION OF DRAWINGS

FIG. 1 is an exploded view of the utility model;

FIG. 2 is a structural schematic diagram of the utility model;

FIG. 3 is a sectional view of the utility model;

FIG. 4 is a schematic structural diagram of the driving rod in the utility model;

FIG. 5 is a schematic structural diagram of the key cap of the utility model.

### EMBODIMENT

In order to further explain the technical means and effects adopted by the utility model to achieve the predetermined purpose, the specific implementation of the utility model will be described in detail with the attached drawings and preferred embodiments.

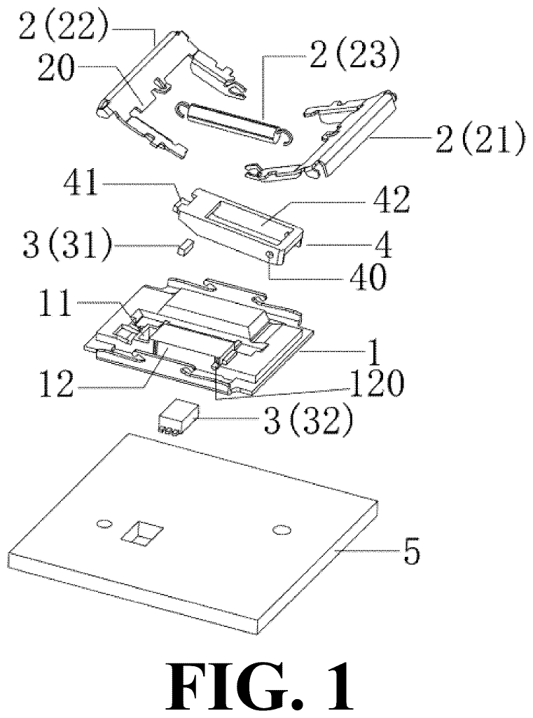

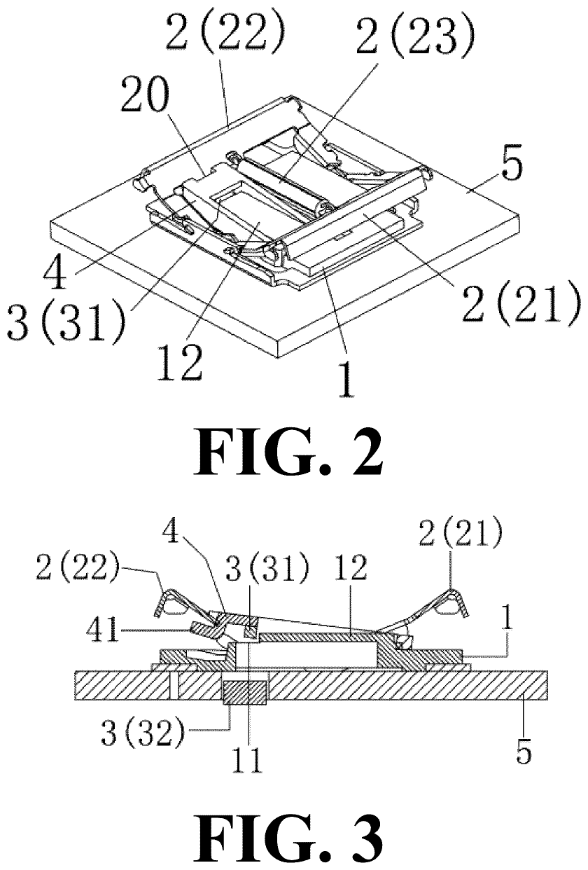

Please refer to FIG. 1 to FIG. 3. The embodiment of the utility model provides a magnetic conduction mechanism applied to a key switch, which comprises a base 1, a balance frame assembly 2 arranged on the base 1, a conduction assembly 3, and a driving rod 4 driven by the balance frame assembly 2 and triggering the conduction assembly 3 to turn on and off. The conduction assembly 3 comprises a magnet 31 linked to the driving rod 4 and an induction switch 32 electrically connected to the PCB 5 and corresponding to the magnet 31.

By pressing the balance frame assembly 2 and moving up and down, the balance frame assembly 2 provides balance and stability for the pressing of the key switch, while the balance frame assembly 2 drives the driving rod 4 to move up and down, and then the driving rod 4 drives the magnet 31 to move up and down, that is, the driving rod 4 provides the pressing force transfer function, thus changing the distance between the magnet 31 and the induction switch 32. When the distance between them reaches the induction distance between them, the circuit is turned on and the key switch is turned on. On the contrary, when the distance between them reaches the induction distance, the key switch is turned on. Therefore, instead of the traditional physical conduction structure, the on-off function of the key switch is realized, which not only has the advantages of difficult aging, long service life, good contact stability, no electrical jitter and the like, but also has high accuracy of on-off action, improves the sensitivity of the key switch, and reduces internal components and the occupation of internal space.

In order to facilitate the driving rod 4 to drive the magnet 31 to move up and down, as shown in FIGS. 1 and 3, a yielding opening 11 for the magnet 31 to move up and down is formed on the base 1 in this embodiment, so that when the driving rod 4 drives the magnet 31 to move up and down, the magnet 31 moves up and down through the yielding opening 11, thereby changing the distance between the magnet 31 and the induction switch 32.

In order to facilitate the induction switch 32 to accurately sense the magnetism of the magnet 31, as shown in FIG. 3, the induction switch 32 is located below the yielding opening 11.

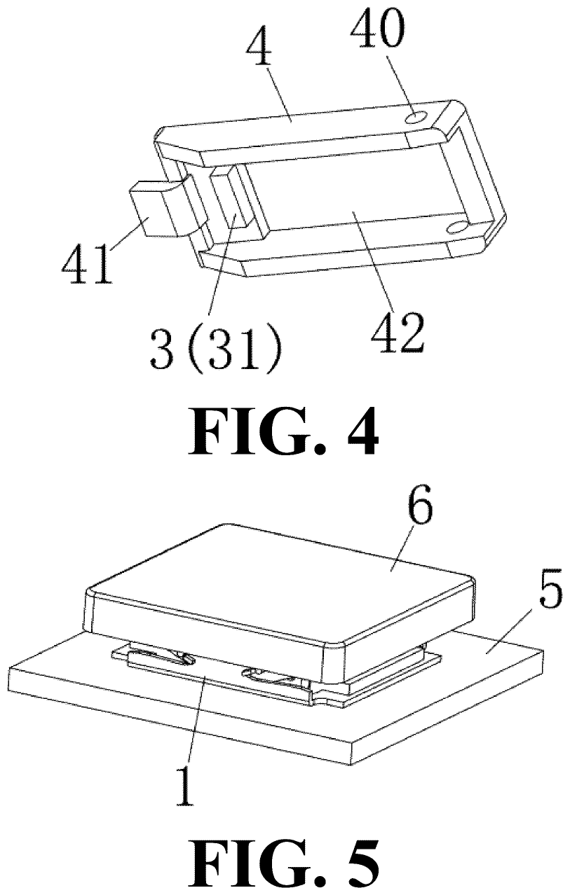

As for the specific installation of the magnet 31, as shown in FIG. 4, the magnet 31 is fixedly arranged on the lower end surface of one end of the driving rod 4, so that the magnet 31 can move up and down with the driving rod 4.

As for the linkage mode between the driving rod 4 and the balance frame assembly 2, a pressing linkage block 41 is arranged at one end of the driving rod 4 close to the magnet 31, and a pressing lug 20 located above the pressing linkage block 41 is convexly arranged on the balance frame assembly 2. When the balance frame assembly 2 moves down under pressure, the pressing projection 20 directly acts on the pressing linkage block 41, thus driving the driving rod 4 to move down.

In this embodiment, in order to improve the operation stability of the driving rod 4, the driving rod 4 drives the magnet 31 to move up and down by swinging. Specifically, an upper opening 42 is formed in the driving rod 4, and a mounting seat 12 embedded in the upper opening 42 is arranged on the base 1. One end of the driving rod 4 far from the pressing linkage block 41 is rotatably connected with the mounting seat 12. Specifically, as shown in FIG. 1, two sides of the mounting base 12 are provided with rotating shafts 120, and the driving rod 4 is provided with mounting holes 40 into which the rotating shafts 120 are inserted, so that the driving rod 4 can rotate along the rotating shafts 120. Therefore, when the driving rod 4 is driven by the balance frame assembly 2 to move up and down, only one end close to the pressing linkage block 41 swings up and down along the rotating shaft 120, so that the driving rod 4 drives the magnet 31 to move up and down in a swinging manner, and the action stability of the driving rod 4 is improved.

In this embodiment, the inductive switch 32 is one of a magnetic inductor and a Hall element.

When the inductive switch 32 is a magnetic sensor, the magnet 31 and the inductive switch 32 are combined to form a magnetic inductive switch. When the inductive switch 32 is a Hall element, the magnet 31 and the inductive switch 32 are combined to form a Hall inductive switch.

Specifically, the working principle of magnetic induction switch is as follows:

In a natural state, when the distance between the magnet 31 on the driving rod 4 and the magnetic inductor on the PCB board 5 is far enough, that is, when the distance between the magnet 31 and the magnetic inductor is greater than the induction distance between them, the magnetic inductor on the PCB board 5 cannot sense the magnetism of the magnet 31, and the circuit is disconnected, that is, the magnetic induction switch is in an off state.

When the balance frame assembly 2 is pressed down, it drives the driving rod 4 and the magnet 31 to move down. When the balance frame assembly 2 is pressed down to a certain stroke, when the distance between the magnet 31 and the magnetic inductor reaches the induction distance between them, the magnetic inductor senses magnetism and the circuit is turned on, that is, the magnetic induction switch is in the on state.

When the pressure on the balance frame assembly 2 is released, under the elastic restoring force of the tension spring 23 described below, the balance frame assembly 2 moves up to reset, driving the driving rod 4 and the magnet 31 to move up. When the distance between the magnet 31 and the magnetic inductor is greater than the inductive distance between them, the magnetic inductor can't sense the magnetism of the magnet 31, the circuit is disconnected, and the magnetic induction switch returns to the off state.

Specifically, the working principle of Hall induction switch is as follows:

In a natural state, when the distance between the magnet 31 on the driving rod 4 and the Hall element on the PCB board 5 is far enough, that is, when the distance between the magnet 31 and the Hall element is greater than the induction distance between them, the Hall element cannot sense the magnetism of the magnet 31, that is, the Hall element does not generate a signal, and the circuit is disconnected, that is, the Hall induction switch is in an off state.

When the balance frame assembly 2 is pressed down, it drives the driving rod 4 and the magnet 31 to move down. When the balance frame assembly 2 is pressed down to a certain stroke, when the distance between the magnet 31 and the Hall element reaches the induction distance between them, the Hall element senses magnetism, that is, the Hall element generates signals (for example, the signal of changing resistance value and the signal of changing voltage value, etc.).

With the increase of magnetic force, the signal value also increases linearly, and the electrical performance is output.

When the pressure on the balance frame assembly 2 is released, under the elastic restoring force of the tension spring 23 described below, the balance frame assembly 2 moves up and returns, driving the driving rod 4 and the magnet 31 to move up. When the distance between the magnet 31 and the Hall element is greater than the induction distance between them, the Hall element cannot sense the magnetism of the magnet 31, that is, the Hall element does not generate a signal, the circuit is disconnected, and the Hall induction switch returns to the off state.

In this embodiment, as shown in FIG. 1, the balance frame assembly 2 includes a balance frame A 21 rotatably connected to the base 1, a balance frame B 22 rotatably connected to the base 1 and the balance frame A 21 respectively, and a tension spring 23 connected between the balance frame A 21 and the balance frame B 22. The balance frame assembly 2 provides balance and stability for pressing the key switch, and at the same time, the tension spring 23 provides elastic restoring force for pressing and resetting. In specific use, a key cap 6 is installed on the balance frame A 21 and the balance frame B 22, as shown in FIG. 5. The specific structure of the balance frame A 21 and the balance frame B 22, and the installation mode with the key cap 6 are not the innovation points of this utility model. For the specific structure, please refer to the utility model patent with the patent number of 202121092814.4 and the patent name is “a photoelectric key switch for increasing the pressing feel”, which is not repeated here.

What needs to be explained here is that the magnetic conduction mechanism disclosed in this utility model is an improvement of the specific structure and a specific control mode, which is not an innovation of this utility model. The magnets, PCB boards, induction switches, magnetic inductors, Hall elements and other parts involved in this utility model can be common standard parts or parts known to those skilled in the art, and their structures, principles and control methods are known to those skilled in the art through technical manuals or conventional experimental methods.

The above is only the preferred embodiment of this utility model, and it does not limit the technical scope of this utility model. Therefore, other structures obtained by adopting the same or similar technical features as the above embodiments of this utility model are within the protection scope of this utility model.

What is claimed is:

1. The invention relates to a magnetic conduction mechanism applied to a key switch, which is characterized by comprising a base, a balance frame component arranged on the base, a conduction component, and a driving rod driven by the balance frame component and triggering the conduction component to be turned on and off, wherein the conduction component comprises a magnet linked with the driving rod, and an induction switch electrically connected to a PCB and corresponding to the magnet.

2. The magnetic conduction mechanism applied to the key switch according to claim 1 is characterized in that a yielding opening for the magnet to move up and down is formed on the base.

3. The magnetic conduction mechanism applied to the key switch according to claim 2 is characterized in that the inductive switch is located below the yielding opening.

4. The magnetic conduction mechanism applied to the key switch according to claim 1 is characterized in that the magnet is fixedly arranged on the lower end face of one end of the driving rod.

5. The magnetic conduction mechanism applied to the key switch according to claim 1 is characterized in that a pressing linkage block is arranged on one end of the driving rod close to the magnet, and a pressing lug located above the pressing linkage block is convexly arranged on the balance frame assembly.

6. The magnetic conduction mechanism applied to the key switch according to claim 5 is characterized in that an upper opening is formed on the driving rod, a mounting seat embedded in the upper opening is arranged on the base, and one end of the driving rod far away from the pressing linkage block is rotatably connected with the mounting seat.

7. The magnetic conduction mechanism applied to the key switch according to claim 1 is characterized in that the inductive switch is one of a magnetic inductor and a Hall element.

8. The magnetic conduction mechanism applied to the key switch according to claim 1 is characterized in that the balance frame assembly comprises a balance frame A rotatably connected to the base, a balance frame B rotatably connected to the base and the balance frame A respectively, and a tension spring connected between the balance frame A and the balance frame B.
